(19) United States
(12) Patent Application Publication
(10) Pub. No.: US 2007/0075279 A1
(43) Pub. Date: Apr. 5, 2007

(54) Method and system for automatically inspecting a display including a layer of liquid crystal material

(75) Inventors: Mark A. Michniewicz, Holly, MI (US); Andrew Blowers, Sebewaing, MI (US)

Correspondence Address: BROOKS KUSHMAN P.C., 1000 TOWN CENTER, TWENTY-SECOND FLOOR, SOUTHFIELD, MI, 48075, US

(73) Assignee: Intergral Vision, Inc., Farmington Hills, MI (US)

(21) Appl. No.: 11/241,528

(22) Filed: Sep. 30, 2005

(51) Int. Cl. G01N 21/86

(52) U.S. Cl. 250/559.27

(57) ABSTRACT

A system and method are provided to rapidly inspect Liquid Crystal On Silicon (i.e., LCOS) displays to identify non-uniform cell gaps. The system includes a light source, a single polarized optical filter, and a color camera. The image acquired by the camera is analyzed to find variations in color. Excessive variations in color are used to identify excessive variations in the cell gap of the LCOS display. The arrangement of the components of the system does not require great precision and the analysis can be done very quickly.

### BACKGROUND OF THE INVENTION 1. Field of the Invention

This invention relates to methods and systems for automatically inspecting a display including a layer of liquid crystal material. 2. Background Art

A Liquid Crystal On Silicon (LCOS) display consists of a layer of liquid crystal material sandwiched between a flat substrate made of monocrystalline silicon and a flat sheet of glass. The liquid crystal material is birefringent; its major and minor axes of birefringence are always at 90 degrees to each other and are both located in the plane parallel to the surface of the glass covering the top of the LCOS display. When the LCOS display is made, the liquid crystal material is treated so that its major and minor axes of birefringence are usually oriented parallel to the top and side edges of the generally rectangular LCOS display.

The silicon substrate is actually an integrated circuit containing transistors, resistors and other circuitry together with metallized areas which serve as electrodes to apply voltage to particular small areas of the liquid crystal material. Each one of these small areas is called a pixel. Depending on the construction method, the sheet of glass may have a transparent, thin coat of metal applied to its lower surface in contact with the liquid crystal material to serve as a return path for the voltage applied to the liquid crystal material from the upper silicon surface. When voltage is applied to a particular area (a pixel) of the liquid crystal, the birefringent liquid crystal material changes its molecular orientation so that light passing through it has its polarization rotated by an amount based on the applied voltage. Depending on the nature of the liquid crystal material used, the polarization rotation effects may be either present when no voltage is applied and decrease when voltage is applied, or the polarization rotation effects may be absent when no voltage is applied and increase with increasing voltage. The methods of this invention apply to either type of display.

Since monocrystalline silicon is not transparent, the LCOS display is used in reflective mode. The LCOS display is illuminated with a source of polarized light and the light reflected from the silicon substrate, after passing through the liquid crystal material twice (once going in and again coming out), is viewed through another polarizing filter. Depending on the voltage applied to each pixel of the display, the polarization of the illuminating light is rotated so more or less of its passes through the viewing polarization filter. In this way, an image can be formed.

In a LCOS display, the thickness of the cell gap, essentially the thickness of the liquid crystal material itself, is made very thin, approximately the thickness of a single wavelength of visible light. This results in a display which responds very quickly to changes in voltage applied to the liquid crystal material. However, when the cell gap is as thin as a single wavelength of visible light, very small differences in cell gap across the area of the display cause localized variations of brightness and/or color in the image on the display. It is both very desirable and very difficult to make LCOS displays with a very thin cell gap which is exactly the same across the entire display.

Measuring the thickness of something that is only one wavelength of visible light thick is not easy. Many different methods exist to measure the exact value of the cell gap across the entire viewable area of the liquid crystal display. However, these methods use multi-color illumination schemes and/or complex optics, and have very tight tolerances in their mechanical systems. By their nature, the methods used to measure the exact cell gap thickness are not well suited to making measurements quickly to meet the requirements of high volume, high speed manufacturing.

In many cases, it is not necessary to know the exact value of the cell gap, so long as it is substantially the same across the entire viewable area.

The following U.S. patent documents are related to the present invention: 5,532,823; 5,757,978; 5,966,195; 6,081,337; 6,538,754; 6,636,322; 6,757,062; and 2004/0233432.

### SUMMARY OF THE INVENTION

An object of the present invention is to provide a method and system for automatically inspecting a display including a layer of liquid crystal material in a quick and inexpensive fashion, without complex optics, structured light or tight mechanical tolerances to identify unacceptable variations in cell gap thickness across a viewable area of the display.

In carrying out the above object and other objects of the present invention, a method for automatically inspecting a display including a layer of liquid crystal material to identify unacceptable variations in thickness of the layer of material is provided. The method includes generating a color image of the display in a detector plane, measuring radiant energy in the image in the detect or plane to produce a signal and processing the signal to identify variations in color and distribution of the variations in the image corresponding to unacceptable variations in thickness in the layer of material.

The step of generating may include the step of illuminating the display with light having a plurality of different wavelengths at an illumination angle so that the light travels through the layer a distance between upper and lower surfaces of the layer at least once to obtain a transmitted light signal having a polarization rotated an amount based on the distance that the light travels through the layer.

The step of generating may further include filtering the transmitted light signal to obtain a colored light signal.

The method may further include applying a voltage across the layer between the upper and lower surfaces so that the polarization of the light signal is rotated a desired amount based on the applied voltage.

The light may travel the distance between the upper and lower surfaces twice.

The display may be an LCOS display.

The light may be visible light or white light.

The illumination angle may be substantially ninety degrees.

The step of illuminating may include the step of polarizing the light.

The steps of polarizing and filtering may be performed with a single optical filter.

The step of processing may produce a distance image representing phase shift due to birefringence variation caused by the variations in thickness.

The step of processing may include processing the distance image to produce a series of connectivity images representing phase contours.

The step of processing may further include the steps of measuring the number of phase contours to obtain the number of fringes and measuring amount of coverage of the phase contours to indicate severity of variations of thickness.

Still further in carrying out the above object and other objects of the present invention, a system for automatically inspecting a display including a layer of liquid crystal material to identify unacceptable variations in thickness of the layer of material is provided. The system includes a means for generating a color image of the display in a detector plane, a plurality of photo detectors for measuring radiant energy in the image in the detector plane to produce a signal, and a signal processor for processing the signal to identify variations in color and distribution of the variations in the image corresponding to unacceptable variations in thickness in the layer of material.

The means for generating may include a source of light having a plurality of different wavelengths, the source of light being arranged to illuminate the display at an illumination angle so that the light travels through the layer a distance between upper and lower surfaces of the layer at least once to obtain a transmitted light signal having a polarization rotated an amount based on the distance that the light travels through the layer.

The means for generating may further include a filter arranged to filter the light signal to obtain a colored light signal.

The system may include a voltage source for applying a voltage across the layer between the upper and lower surfaces so that the polarization of the light signal is rotated a desired amount based on the applied voltage.

The light may travel the distance between the upper and lower surfaces twice.

The display may be an LCOS display.

The light may be visible light or white light.

The illumination angle may be substantially ninety degrees.

The filter may be arranged to also polarize the light.

The filter may be a linearly polarized optical filter.

The plurality of photo detectors may include a CCD detector having a plurality of sensing elements.

The signal processor may process the signal to produce a distance image representing phase shift due to birefringence variations caused by the variations in thickness.

The signal processor may further process the distance image to produce a series of connectivity images representing phase contours.

The signal processor may further measure the number of phase contours to obtain the number of fringes and may measure amount of coverage of the phase contours to indicate severity of variations in thickness.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a side schematic view of a LCOS display and a voltage source;

FIG. 2 is a top schematic view of the display of FIG. 1 with axes of birefringence superimposed thereon;

FIG. 3 is a schematic view of one embodiment of a system for automatically inspecting the display of FIGS. 1 and 2; and

FIG. 4 is a schematic block diagram flow chart illustrating one embodiment of a fringe detection algorithm performed by a signal processor of the present invention.

### DETAILED DESCRIPTION OF THE PREFERRED EMBODIMENT(S)

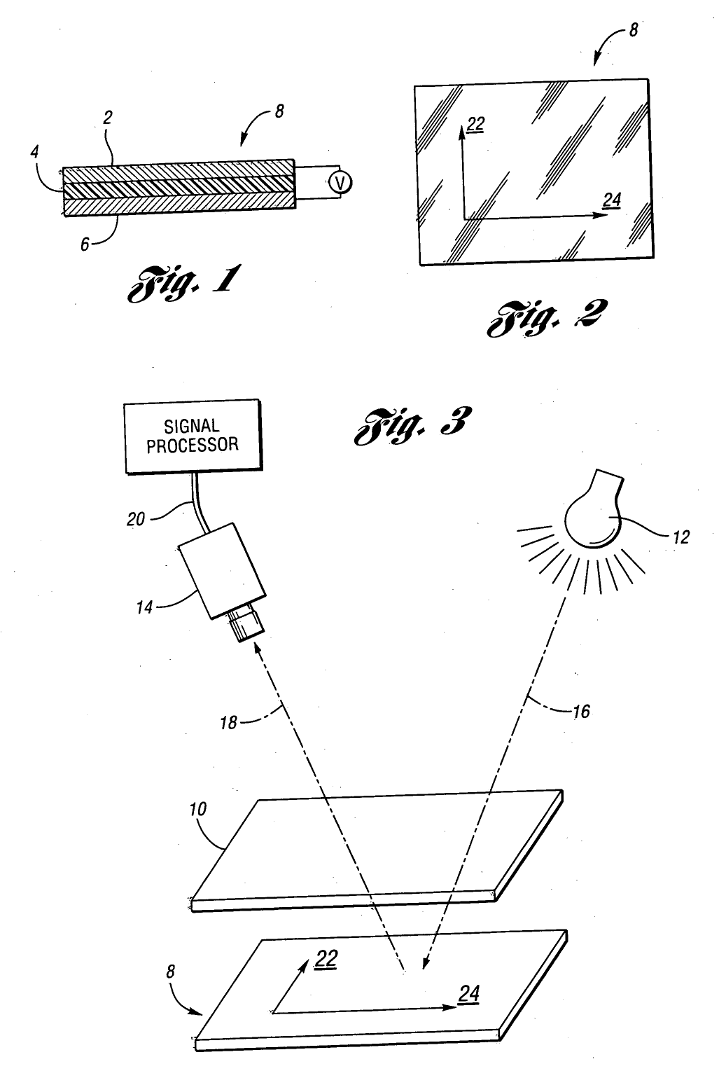

Referring now to the drawing figures, FIG. 1 illustrates the construction of a Liquid Crystal On Silicon (i.e., LCOS) display, generally indicated at 8. A layer of liquid crystal material 4 is sandwiched between a substrate of monocrystalline silicon 6 and a flat piece of glass 2.

FIG. 2 illustrates, at 22 and 24, how the major and minor axes of birefringence of the liquid crystal material 4 are oriented with respect to the edges of the LCOS display 8. Depending on the type of liquid crystal material used, these axes of birefringence may be present when the display is de-energized (no voltage applied to the pixels) or they may only appear when the display is energized with a particular voltage.

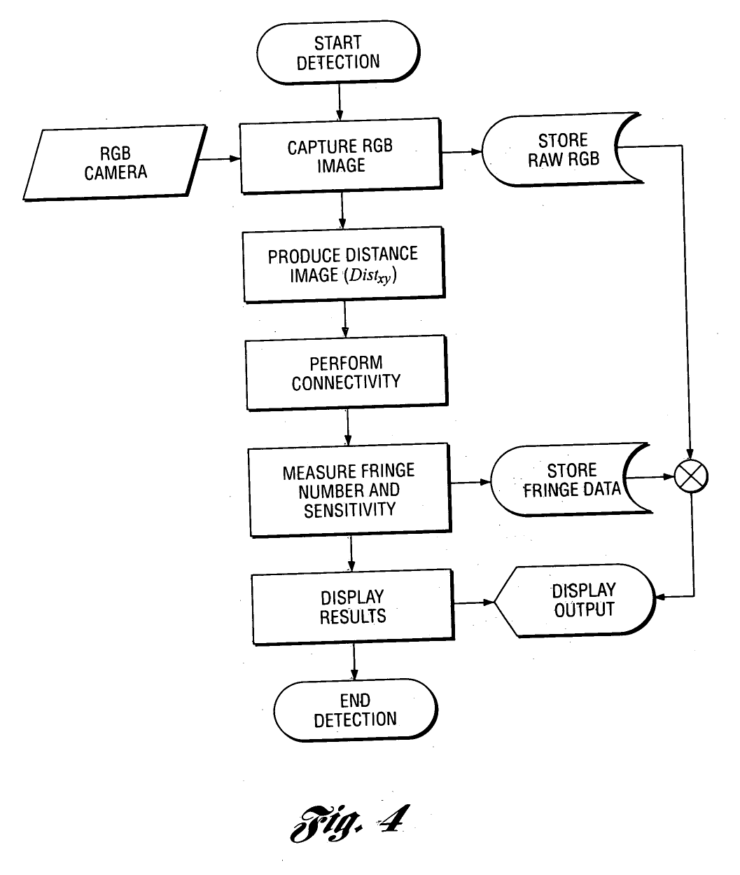

FIG. 3 shows an embodiment of a system constructed in accordance with the present invention. A linear polarization filter 10 is located in a plane parallel to the liquid crystal display 8 so that light from a light source 12, illustrated by dotted arrow 16, passes through the polarizing filter 10 to illuminate the liquid crystal display 8. Light reflected from the liquid crystal display 8, illustrated by dotted arrow 18, also passes through the linear polarization filter 10 to reach a detector plane within a camera 14. A plurality of photo detectors measures typically radiant energy in the image in the detector plane within the camera 14 to produce an electronic signal. A cable 20 from the camera 14 conveys the electronic signal representing the image captured by the camera 14 to a computer or other device for analysis such as a signal processor.

One aspect of the invention is to allow quick identification of LCOS displays which are defective for reasons of too much variation in the thickness of the liquid crystal material, also called the cell gap.

The nature of the invention does not require precise placement of the LCOS display 8 in relation to the inspection apparatus or system. The inspection method does not require a light source having especially uniform illumination across the field of view or which has special color characteristics. Ordinary white light generated by an incandescent light bulb, is sufficient. Only one simple, single linear polarizing filter is required in one embodiment of the invention.

The camera 14 used in the inspection apparatus does not need to have especially high resolution, high light sensitivity or even especially good color rendition. Since the analysis method uses relative variations of color and not brightness, it is very tolerant of camera shortcomings.

Still referring to FIG. 3, the optical linear polarizing filter 10 has an axis of polarization oriented at 45 degrees with respect to the major (arrow 24) and minor (arrow 22) axes of birefringence of the LCOS display 8 being inspected. The plane of the polarizing filter 10 may be parallel to the plane of the liquid crystal material layer 4 in the LCOS display 8. The distance between the polarizing filter 10 and the LCOS display 8 is not critical and may be adjusted to practically any value to fit the requirements of the light source 12 and the camera 14.

The camera 14 is focused on the liquid crystal display 8 and views the liquid crystal display through the same polarizing filter 10 that is used to filter the light from light source 12. The use of the same polarization filter 10 for both illumination and viewing eliminates many issues of alignment and matching of filters.

The light source 12 should be of a type which has a relatively smooth distribution of wavelengths of light throughout the optical spectrum. The illuminating light may have at least some intensity at every wavelength in the optical spectrum, although the intensity does not need to be uniform across the entire spectrum. The optical spectrum used can be in the region visible to the human eye, or it can be in the infrared or ultraviolet region. An ordinary incandescent light source is also satisfactory.

The light illuminating the LCOS display 8 does not need to be precisely the same intensity at every point. Because the analysis of the image looks for color variations, minor differences in light intensity across the surface of the liquid crystal display have no effect. The only restriction on light intensity is that it have no sharp edged shadows or changes in intensity.

The camera 14 is a camera which produces an electronic signal to. represent the image, such as a video camera. The video camera 14 should be a camera capable of producing color images. The camera 14 sends the signal representing the color image along the cable 20 to a computer or other device (i.e., signal processor) where it is analyzed. The computer or other device used for analyzing the image is of a common type, readily available in the commercial marketplace.

Signal Processing—Fringe Detection Algorithm

The following is a description of the fringe detection algorithm performed by instructions of software loaded on a computer and used to process the image data captured by the optical system. The algorithm is described with reference to FIG. 4.

The optical system produces an image where variations in the cell gap result in a dominant wavelength shift in the polarized light due to the birefringent nature of LCD material. The information is captured via a standard three CCD NTSC color camera 14, where one CCD is band-pass filtered for red, one for green, and one for blue. (This method can be used with any method of spatial color imaging, e.g., filter wheel, Bayesian color filtering etc., and at any resolution.)

The algorithm performs a normalized color distance process to the image as indicated by the following equation:

$${Dist}_{xy} = ‖ \frac{{B}_{xy}}{{R}_{xy} + {G}_{xy} + {B}_{xy}} - \frac{{R}_{xy} + {B}_{xy}}{{R}_{xy} + {G}_{xy} + {B}_{xy}} \vert - \frac{{R}_{xy}}{{R}_{xy} + {G}_{xy} + {B}_{xy}} \vert$$

to produce a monochrome image representing the phase shift due to the birefringence variation caused by the deviations in the cell gap. (To human perception this shift is visible as a deviation from a neutral color (black, gray, white) towards red or blue depending on the phase.) Once the monochrome distance image is produced, it is further processed to produce a series of connectivity images representing the phase contours. These contours are counted to give the number of fringes, and measured for their percentage coverage to indicate severity.

Additional processing on this data may be done for failure analysis but that is an independent process from the fringe detection.

As depicted by the arrows 16 and 18 in FIG. 3, light from the light source 12 illuminates the LCOS display 8 through the polarizing filter 10 and the camera 14 views the light reflected from the LCOS display 8, through the same polarizing filter 10. The light source 12 and the camera 14 are arranged so that the angle of illumination (arrow 16) is approximately complementary to the angle of viewing (arrow 18). The angles at which the light impinges or is viewed with respect to the plane of the liquid crystal display 8 that is being inspected may be approximately perpendicular to the plane of the display 8.

Because of the almost perpendicular angle of the light, very little light is reflected off the top surface of the glass 2 back to the camera 14. Most of the light reaching the camera 14 is reflected off the silicon 6 and, in doing so, passes twice through the layer of liquid crystal material 4.

Light from light source 12 which penetrates into the birefringent liquid crystal material 4 of the LCOS display 8 has its polarization rotated by an amount related to the thickness of the liquid crystal material 4 before it reflects off the upper surface of the silicon 6. After reflection, the light again passes through the liquid crystal material 4 and has its polarization rotated some more before exiting. The birefringent characteristics of the liquid crystal material 4 cause different polarization rotations at different wavelengths (or colors) of light. As a result of the polarization shift caused by the liquid crystal material 4, different wavelengths (or colors) of light arrive at the polarization filter 10 with different polarization rotations with respect to the filter 10. Some colors are blocked more than others and the result, after passing through the filter 10, is light with a distinct color. This light, depicted by the arrow 18, is imaged by the camera 14.

If the layer of liquid crystal material 4 is completely uniform in thickness, the image of the LCOS display 8 as viewed by the camera 14 will be a completely uniform color. Any differences in thickness of the liquid crystal material 4 will cause an overall difference in polarization rotation of the light passing through it and will result in a different color in that area as viewed by the camera 14. Analysis of the amount of color variation and the size of the area it covers allows identification of LCOS displays which have excessively non-uniform cell gap.

Another way to understand how the characteristics of the LCOS display 8 and the polarizing filter 10 make colored light from white light is to look at the birefringent characteristics of the liquid crystal material 4. Any light passing through the liquid crystal material 4 gets filtered into two vectors of polarization at 90 degree angles to each other, corresponding to the major and minor axes 24 and 22, respectively, of birefringence of the liquid crystal material 4. Passing the light from the light source 12 through a linear polarization filter oriented at 45 degrees to the major and minor axes 24 and 22, respectively, of birefringence in the liquid crystal material 4 assures that the light illuminating the liquid crystal material 4 has equal intensity along the two axes 22 and 24 of birefringence. The speed at which light passes through the liquid crystal material 4 is slightly different along each of its two axes 22 and 24 of birefringence. When the two vectors of polarized light leaving the liquid crystal material 4 encounter the linear polarizing filter 10, interference occurs between the two vectors so that at certain wavelengths of light, destructive interference reduces their intensity and at other wavelengths, constructive interference increases their intensity. Thus, the light reaching the camera 14 has a different color than the illuminating light.

In one embodiment of this invention, a diffused, incandescent light source 12 is used for illumination. The distance between the light source 12 and the LCOS display 8 being inspected is approximately one meter. The polarizing filter 10 is located parallel to the front surface of the LCOS display 8 and approximately 3 centimeters above it. The camera 14 is located approximately one meter away from LCOS display 8. The light source 12 and the camera 14 are located so that the light entering and leaving the LCOS display 8 to be viewed by the camera 14 is approximately perpendicular to the plane of the display 8.

If the polarizing filter 10 is not precisely parallel to the liquid crystal display 8, it causes an overall change of color as viewed by the camera 14 which is uniform across the field of view. Since the analysis method only looks for variations in color from one area to another on the liquid crystal display 8, this has no negative effect.

A single image or frame acquired from the camera 14 is sufficient. However, if a more detailed analysis is required, multiple frames can be averaged together to overcome noise in the camera electronics or to average out any mechanical vibration in the inspection apparatus. With the proper type of camera 14 and software in the analysis computer (i.e., signal processor), liquid crystal displays can be inspected “on the fly” as they move along on a conveyor, without having to stop them or put them in a fixture to hold them in a particular location and orientation. The speed at which liquid crystal displays can be inspected is limited only by the speed of the camera 14 and the signal processor.

In summary, one embodiment of a system constructed in accordance with the invention includes a white light source 12, a linear optical polarizer 10, a color video camera 14, and a signal processor to analyze the image captured by the color camera 14. Additional lenses, diffusers or other apparatus may be employed to direct the light from the light source 12 to illuminate the desired area and to focus the camera 14 on the viewable area of the display 8. The polarizer 10 is located above and parallel to the viewing surface of the liquid crystal display 8 with its polarization at a 45 degree angle to both the major and minor axes 24 and 22 of birefringence of the LCOS display 8. The light from the source 12 passes through the polarizer 10 to illuminate the liquid crystal display 8 and the color camera 14 views the liquid crystal display 8 through the same polarizer 10. All the pixels in the LCOS display 8 are energized with the same voltage by a voltage source shown in FIG. 1. The voltage applied to the pixels may be adjusted to any voltage (including zero) to achieve a desired amount of polarization rotation for the light passing through the liquid crystal material 4. The electronic signal representing the image from the color camera 14 is conveyed by the cable 20 to a computer (i.e., signal processor) or other device to analyze the image captured by the camera 14 to identify variations in color in the image of the viewable area of the liquid crystal display 8. A “perfect” LCOS display 8 will have no variation in color across the viewable area. A less than perfect display 8 will have variations in color in the image of the viewable area. The amount of color difference and the distribution of that difference across the viewable area of the LCOS display 8 indicates the variation in cell gap thickness.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for automatically inspecting a display including a layer of liquid crystal material to identify unacceptable variations in thickness of the layer of material, the method comprising:
generating a color image of the display in a detector plane;
measuring radiant energy in the image in the detector plane to produce a signal; and
processing the signal to identify variations in color and distribution of the variations in the image corresponding to unacceptable variations in thickness in the layer of material.

2. The method as claimed in claim 1, wherein the step of generating includes the step of illuminating the display with light having a plurality of different wavelengths at an illumination angle so that the light travels through the layer a distance between upper and lower surfaces of the layer at least once to obtain a transmitted light signal having a polarization rotated an amount based on the distance that the light travels through the layer.

3. A method as claimed in claim 2, wherein the step of generating further includes filtering the transmitted light signal to obtain a colored light signal.

4. The method as claimed in claim 2 further comprising applying a voltage across the layer between the upper and lower surfaces so that the polarization of the light signal is rotated a desired amount based on the applied voltage.

5. The method as claimed in claim 2, wherein the light travels the distance between the upper and lower surfaces twice.

6. The method as claimed in claim 1, wherein the display is an LCOS display.

7. The method as claimed in claim 2, wherein the light is visible light.

8. The method as claimed in claim 2, wherein the light is white light.

9. The method as claimed in claim 2, wherein the illumination angle is substantially ninety degrees.

10. The method as claimed in claim 3, wherein the step of illuminating includes the step of polarizing the light and wherein the steps of polarizing and filtering are performed with a single optical filter.

11. The method as claimed in claim 1, wherein the step of processing produces a distance image representing phase shift due to briefing gence variation caused by the variations in thickness.

12. The method as claimed in claim 11, wherein the step of processing processes the distance image to produce a series of connectivity images representing phase contours.

13. The method as claimed in claim 12, wherein the step of processing includes the steps of measuring the number of phase contours to obtain the number of fringes and measuring amount of coverage of the phase contours to indicate severity of variations of thickness.

14. A system for automatically inspecting a display including a layer of liquid crystal material to identify unacceptable variations in thickness of the layer of material, the system comprising:
means for generating a color image of the display in a detector plane;
a plurality of photo detectors for measuring radiant energy in the image in the detector plane to produce a signal; and
a signal processor for processing the signal to identify variations in color and distribution of the variations in the image corresponding to unacceptable variations in thickness in the layer of material.

15. The system as claimed in claim 14, wherein the means for generating further includes a source of light having a plurality of different wavelengths, the source of light being arranged to illuminate the display at an illumination angle so that the light travels through the layer a distance between upper and lower surfaces of the layer at least once to obtain a transmitted light signal having a polarization rotated an amount based on the distance that the light travels through the layer.

16. A system as claimed in claim 15, wherein the means for generating further includes a filter arranged to filter the light signal to obtain a colored light signal.

17. The system as claimed in claim 15, further comprising a voltage source for applying a voltage across the layer between the upper and lower surfaces so that the polarization of the light signal is rotated a desired amount based on the applied voltage.

18. The system as claimed in claim 15, wherein the light travels the distance between the upper and lower surfaces twice.

19. The system as claimed in claim 14, wherein the display is an LCOS display.

20. The system as claimed in claim 15, wherein the light is visible light.

21. The system as claimed in claim 15, wherein the light is white light.

22. The system as claimed in claim 15, wherein the illumination angle is substantially ninety degrees.

23. The system as claimed in claim 16, wherein the filter is arranged to also polarize the light.

24. The system as claimed in claim 23, wherein the filter is a linearly polarized optical filter.

25. The system as claimed in claim 14, wherein the plurality of photo detectors includes an CCD detector having a plurality of sensing elements.

26. The system as claimed in claim 14, wherein the signal processor processes the signal to produce a distance image representing phase shift due to birefringence variations caused by the variations in thickness.

27. The system as claimed in claim 26, wherein the signal processor processes the distance image to produce a series of connectivity images representing phase contours.

28. The system as claimed in claim 27, wherein the signal processor measures the number of phase contours to obtain the number of fringes and measures amount of coverage of the phase contours to indicate severity of variations in thickness.
